(19) United States
(12) Patent Application Publication
(10) Pub. No.: US 2002/0073133 A1
(43) Pub. Date: Jun. 13, 2002

(54) Register allocation method and software development method for various execution environments and LSI for executing developed software

(76) Inventors: Satoshi Misaka, Kokubunji (JP); Kazuo Aisaka, Kokubunju (JP); Toshiyuki Aritsuka, Kodaira (JP)

Correspondence Address: Stanley P. Fisher, Reed Smith Hazel & Thomas LLP, Suite 1400, 3110 Fairview Park Drive, Falls Church, VA, 22042-4503, US

(21) Appl. No.: 10/006,304

(22) Filed: Dec. 10, 2001

(30) Foreign Application Priority Data
Dec. 13, 2000 (JP) 2000-378801

(51) Int. Cl. G06F 9/00

(52) U.S. Cl. 709/102

(57) ABSTRACT

The invention provides a method for allocating registers for various execution environments. Various arguments are passed when a program for unifying various execution environments is called, then the parameters are stored in an argument information set part created in a memory's area pointed to by a general-purpose register. Accordingly, the number of registers actually used for storing the passed arguments is adjusted to be no greater than the number of registers reserved for storing the passed arguments. The number of passed arguments specified for a common function is also suppressed to be no greater than the number of registers for storing the passed arguments. The memory utilization efficiency is thus improved while the program execution speed is prevented from decreasing.

### BACKGROUND OF THE INVENTION

1. Field of the Invention

The present invention relates to a register allocation method and a software development method for generating an executable program which can be executed in various execution environments. In particular, the invention relates to a register allocation method and a software development method for developing software which can be executed in various execution environments wherein an executable program to be executed by a CPU can be ported from one execution environment to another easily by increasing a memory utilization efficiency without reducing the execution speed of the software.

2. Description of the Prior Art

Some conventional software developing technologies allowing an executable program to be generated across various execution environments.

The Japanese Patent Laid-open No. Hei 8-63363 titled as “Virtual Execution Environment System” discloses a virtual execution environment system as explained by referring to FIG. 6 as follows.

FIG. 6 is a diagram showing the configuration of the virtual execution environment system disclosed in Japanese Patent Laid-open No. Hei 8-63363.

The source code of the application software created by the user (or the programmer) includes a program body 11 and an information replacement descriptor 12.

The program body 11 comprises different source codes intended for generating various kinds of application software. The information replacement descriptor 12 is a module for replacing information described in the program body 11 with the information proper for a chosen operating system 60 so as to implement a specific application software under a virtual execution environment.

In order to generate an executable program 30 to be executed under a chosen operating system 60, the program body 11 provides a replacement information described in the replacement information descriptor 12 to a compiler for generating the executable program 30 for the existing operating system 60. The executable program 30 is then executed by an execution part 22. Atranslator 21 shown in FIG. 6 is the compiler for generating the executable program 30 which can be executed in the virtual execution environment.

If a source program written is in the C language, the replacement information descriptor 12 utilizes macro definitions to be processed by a preprocessor of the compiler 21.

As described above, the executable program 30, which can be generated for various execution environments without modifying the program body 11 of the software 10, is then executed in the chosen operating system 60.

The prior art described above was designed to compile an executable program for each of the various assumed execution environments. However, the prior art fails to consider the efficiency of memory utilization and the speed at which an executable program is executed.

Problems of the prior art are explained by referring to FIGS. 7 to 9 as follows.

FIG. 7 is a conceptual diagram showing the generation of an executable program to be executed in each of the various execution environments.

FIG. 8 is a diagram showing the call relations in executing an executable program on a computer system.

FIG. 9 is a diagram showing how registers are assigned when a program A for unifying various execution environments is called.

A configuration of the prior art system and its problems are described as follows.

In this case, there are two systems: an A computer system 105a and a B computer system 105b as shown in FIG. 7. The A computer system 105a and the B computer system 105b respectively provide an A execution environment 104a and a B execution environment 104b each of which is an environment for executing a program. The A execution environment 104a comprises A hardware 106a and an A OS 107a for controlling the A hardware 106a and for serving as an interface between an application program and the A hardware 106a. The B execution environment 104b comprises B hardware 106b and a B OS 107b for controlling the B hardware 106b and for serving as an interface between an application program and the B hardware 106b.

An application body 100 is source code describing a user application. The application body 100 calls a common function 102 in order to utilize another function of the system. It should be noted that the user who writes the application body 100 needs only to be aware of a common function interface 101 and does not have to change the source code in accordance with the execution environment 104. Thus, the application body 100 maintains its integrity at the source level.

The common function 102 provides a library function for software development and the common function interface 101 has been disclosed to the user. In other words, the common function 102 provides the user with the uniform common interface 101, which is independent of any chosen execution environment 104.

After having written the application body 100, the user compiles and links the application body 100 to produce an execution program 110. If the user desires to execute the execution program 110 in the A execution environment 104a, an A compiler 108a is used in compiling work as shown in FIG. 7. If the user desires to execute the execution program 110 in the B execution environment 104b, on the other hand, a B compiler 108b is used in compiling work as shown in FIG. 7.

If the user desires to execute the execution program 10a in the A execution environment 104a, an A linker 109a for the A execution environment 104a is used to link with a program constituting A execution environment program 103a. The A execution environment program 103a is a program allowing the execution program 110a to be executed in the A execution environment 104a. The A execution environment program 103a triggers system calls for the A OS 107a. If the user desires to execute the execution program 110b in the B execution environment 104b, on the other hand, a B linker 109b to the B execution environment 104b is used to link a program constituting B execution environment program 103b. The B execution environment program 103b is a program allowing the execution program 110b to be executed in the B execution environment 104b. The B execution environment program 103b initiates system calls for the B OS 107b.

As described above, the application body 100 serving as source code is compiled and linked to generate an execution program 110a for the A execution environment 104a or to generate an execution program 110b for the B execution environment 104b.

A module obtained as a result of compilation of the common function 102 is linked with the A execution environment program 103a to produce an A program 111a for unifying various execution environments. Furthermore, the module is linked with the B execution environment program 103b to produce a B program 111b for unifying various execution environments.

The following description explains how the control flows when a program developed as described above is executed in its execution environment by referring to FIG. 8. While the A execution environment 104a is used as an example. The following description is also applicable to the B execution environment 104b.

When the control is transferred to the A execution program 110a executed in the A execution environment 104a, the A execution program 110a calls the common function 102 through the common function interface 101. When the common function 102 is called, the control is transferred to the A program 111a for unifying various execution environments.

The A program 111a for unifying various execution environments initiates a system call in order to utilize a function of the A OS 107a. The function of the A OS 107a may in turn initiates the A hardware 106a, if necessary.

The control is returned to the caller (i.e.: the A program 111a) and, finally, to the A execution program 110a.

When the executable code of the A execution program 110a calls the common function 102, arguments are passed by registers of the A hardware 106a and a memory. The return value of the common function 102 is also passed by registers of the A hardware 106a and the memory.

From the standpoint of the A execution program 110a, passed arguments are arguments of the common function interface 101 which are passed to the A program 111a for unifying various execution environments by the registers of the A hardware 106a and the memory.

The following description explains how the arguments are passed by referring to FIG. 9 and then points out the relevant problems.

In general, a CPU's general-purpose registers allocated by the compiler to data and arguments are classified into two categories, namely, registers accessible to the user and registers accessible to the system. The contents of a register accessible to the user are restricted from being altered by a call for a function. That is, the contents of a register accessible to the user prior to the call for a function are guaranteed to be the same after the call. A register accessible to the user can be directly operated by an assembler. On the other hand, user data stored in a register accessible to the system after a call for a function is not guaranteed to remain the same after the call. Thus, a register used for passing an argument set by the user is also a register accessible to the system.

There are two methods for passing a parameter between modules with a general-purpose register. The first one of the two methods is a direct technique whereby the parameter is stored in the general-purpose register. On the other hand, the second method is an indirect technique whereby the parameter is stored at a location in a memory and the address of the location is then stored in the general-purpose register. As an implementation of the second method, a predetermined area is allocated in the memory for the parameters to be pushed into a stack and the general-purpose register is set with a value pointing to the stack.

It is assumed that the general-purpose registers, which are used when the control is passed to the A execution program 110a, are general-purpose registers 141 to 149 shown in FIG. 9. These general-purpose registers 141 to 149 are used for the following applications.

The general-purpose registers 144 to 146 are used for storing arguments of a called C function. Since these general-purpose registers 144 to 146 are registers accessible to the system, the preservation of any user data in these registers is not guaranteed. These general-purpose registers 144 to 146 are called a parameter-storing register set 150.

The general-purpose registers 142 and 143 are each reserved as a register for storing a local variable of the called C function or a variable stored temporarily. Since these general-purpose registers 142 and 143 are also registers accessible to the system, the preservation of any user data in these registers is not guaranteed.

The general-purpose register 141 is reserved as a register for storing a return value. Since this register is also a register accessible to by the system, the preservation of any user data in this register is not guaranteed. It should be noted that, if a return value is accommodated in the general-purpose register 141, only the 5 register 141 stores the return value. If a return value cannot be accommodated exclusively in the general-purpose register 141, the resister 141 stores a local variable or a temporal variable.

The general-purpose registers 147 and 148 are accessible to the users. The preservation of any user data in these registers is therefore guaranteed for calling a C language function.

The general-purpose register 149 is reserved as a register for storing a stack pointer. The register 149 points to a location in a stack memory 152 allocated in a RAM-A 151. The contents of the general-purpose register 149 after a call for a function are guaranteed to remain the same after the call.

The A compiler 108a further allocates areas of the RAM-A 151 as a heap memory 153 and a stack memory 152.

When control is transferred from the A execution program 110a to the A program 111a for unifying various execution environments, values of arguments described in the common function 102 are stored sequentially in the general-purpose registers 144 to 146 of the parameter-storing register set 150.

If not all of the argument values can be accommodated in the general-purpose registers 144 to 146 of the parameter-storing register set 150, the remaining arguments which are described in the common function 102 and cannot be accommodated in the parameter-storing register set 150 are stored in an A-executable-program stack frame 154 of the stack memory 152.

By analogy, if the returned value of the common function 102 is larger than the size of the general-purpose register 141, a return value stack 156 is allocated in the A-executable-program stack frame 154 and a return address stack 157 pointing to the location of the return value stack 156 is stored in the stack memory 152.

Then, the control is turned to an address of a program stored in a ROM-A 159. The address is pointed to by the contents of a PC (Program Counter) register 158 included in the A hardware 106a. At the address, an instruction of the A program 111a for unifying various execution environments is stored. The program stored in a ROM-A 159 is the A program 111a for unifying various execution environments. By execution of instructions of the A program 111a for unifying various execution environments sequentially, a stack frame 160 for a program unifying various execution environments is stored in the stack memory 152.

Finally, immediately before the PC register 158 points to an instruction of returning from the A program 111a for unifying various execution environments to the A execution program 110a, the area used for storing the stack frame 160 for the program for unifying various execution environments is located in the stack memory 152.

It should be noted that stack frames used as the stack frame 154 for the A executable program and the stack frame 160 for the program for unifying various execution environments program are a set of stack frames for temporarily storing values of local variables of the called C function. The set of stack frames has been allocated in the stack memory by the compiler in advance.

Accordingly, the prior art described above does not consider a relation between the number of arguments of the common function interface 101 and the number of registers in the parameter-storing register set 150. While the arguments are arguments specified when the common function 102 is called, and the registers are the general-purpose registers 144 to 146 for storing the values of the arguments when the control is transferred to the A program 111a for unifying various execution environments.

There shall be no problem if the number of arguments of the common function interface 101 is smaller than the number of registers in the parameter-storing register set 150. But it the number of arguments of the common function interface 101 is greater than the number of registers in the parameter-storing register set 150, the compiler produces codes which stores the remaining argument values in a parameter stack 155 of the stack memory 152. The remaining argument values are arguments' values that cannot be stored in the general-purpose registers 144 to 146.

Thus, when the control is transferred from the A execution program 110a to the A program 111a for unifying various execution environments, extra processing has to be carried out to store the remaining argument values in the parameter stack 155 of the stack memory 152, which raises a problem of reducing execution speed.

Also from the standpoint of utilization efficiency of the stack memory 152, the argument values that cannot be stored in the general-purpose registers 144 to 146 must be stored in the stack memory 152, which requires an increase in size of the RAM 151. As a result, another problem of poorer utilization efficiency of the RAM 151 occurs.

### SUMMARY OF THE INVENTION

The present invention provides a register allocation method and a method for generating an executable program which can be implemented for each of various execution environments. In generating such an executable program for each execution environment, allocation of general-purpose registers in a process of calling a program for unifying various execution environments is designed to improve the efficiency of memory utilization and avoid any decrease in execution speed., The invention also provides an LSI executing an embedded program developed with the register allocation method and the software development method.

In accordance with one embodiment the present invention, the number of arguments of the common function 102 is reduced and, when control is transferred to the A program 111a for unifying various execution environments, an argument information set part 161 for passing arguments is created in a memory and a general-purpose register is set with a value pointing to the argument information set part 161.

By doing so, the processing of storing data in the parameter stack 155 of the stack memory 152 is eliminated so as to reduce the workload in calling for a function during executing a program.

In the prior art, the parameter stack 155 is used so as to increase the amount of stacks. In the present invention, however, an argument information set part 161 is created in a RAM to increase the efficiency of memory utilization.

It is necessary to make the number of arguments of the common function 102 smaller than the number of registers in the parameter-storing register set 150 such that there are enough general purpose registers reserved for storing arguments.

Other and further objects, features and advantages of the invention will appear more fully from the following description.

### BRIEF DESCRIPTION OF THE DRAWINGS

The preferred embodiments of the present invention are illustrated in the accompanying drawings in which:

FIG. 1 is an explanatory diagram describing a processing flow in each execution environment of a method for allocating registers in accordance with the present invention;

FIG. 2 is diagram showing the configuration of hardware for executing a program under the various execution environments wherein registers are allocated in accordance with the present invention;

FIG. 3 is a diagram showing how general-purpose registers are allocated in accordance with the present invention when an A program 111a for unifying various execution environments is called;

FIG. 4 is a diagram showing C-language typical coding which adapts the method of allocating general-purpose registers in accordance with the present invention;

FIG. 5 is a diagram showing how registers are allocated when the A program 111a for unifying various execution environments is called in the case of the coding shown in FIG. 4;

FIG. 6 is a diagram showing the configuration of a virtual execution environment system disclosed in Japanese Patent Laid-open No. Hei 8-63363;

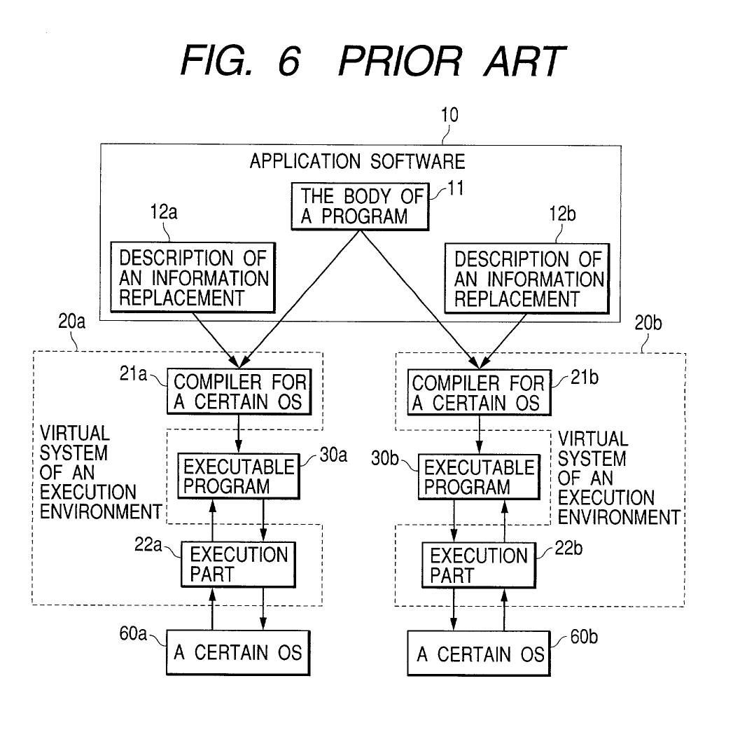

FIG. 7 is a conceptual diagram showing the generation of an executable program to be executed in various execution environments;

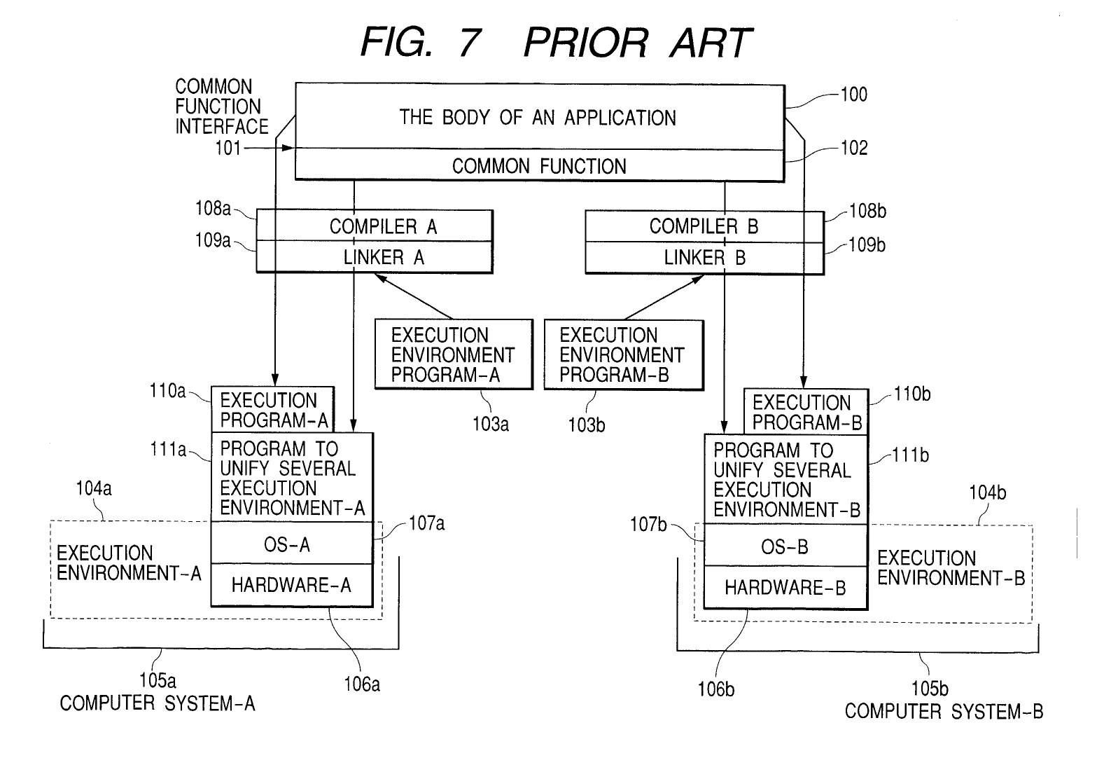

FIG. 8 is a diagram showing the call relations in executing an executable program on a computer system; and

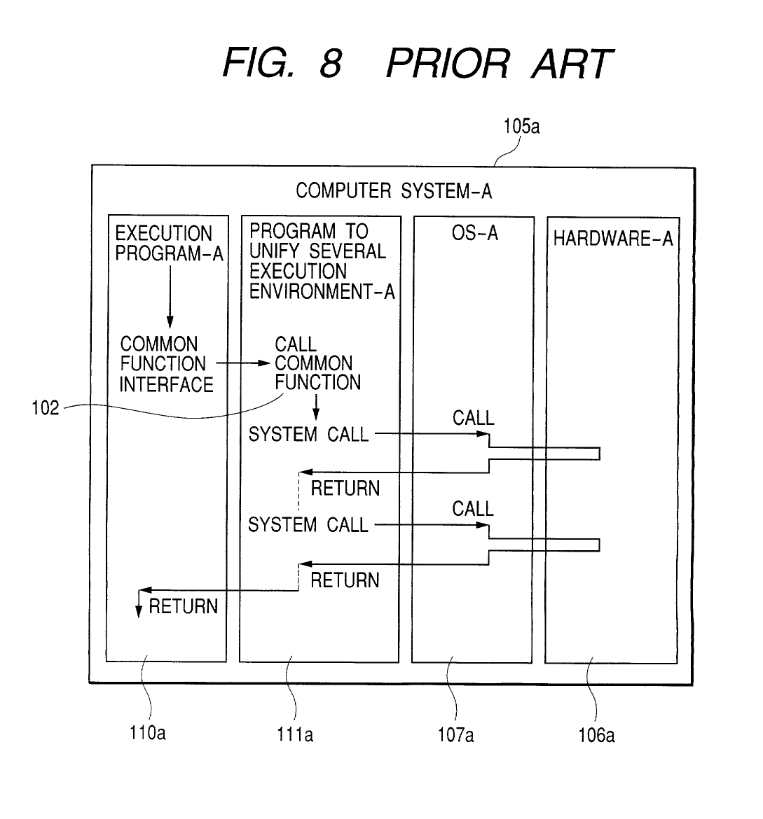

FIG. 9 is a diagram showing how registers are allocated when a program A for unifying various execution environments is called.

### DETAILED DESCRIPTION OF THE PREFERRED EMBODIMENTS

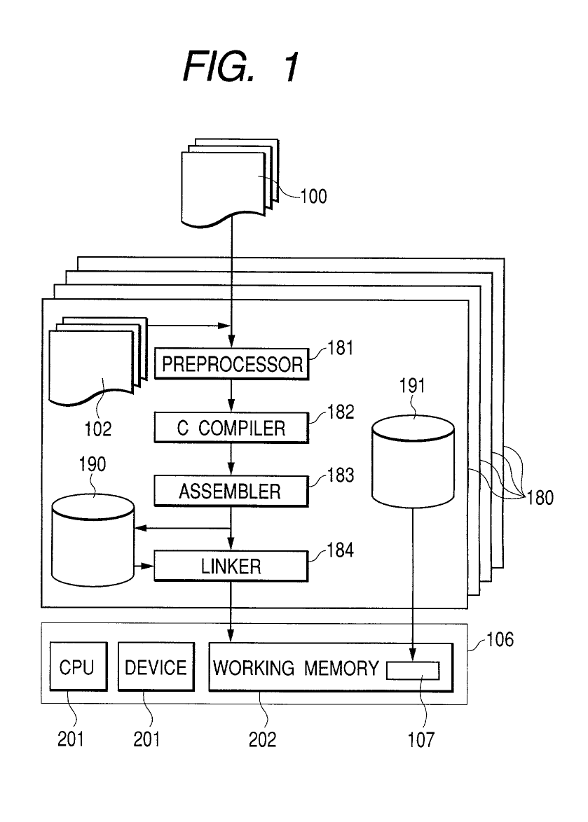

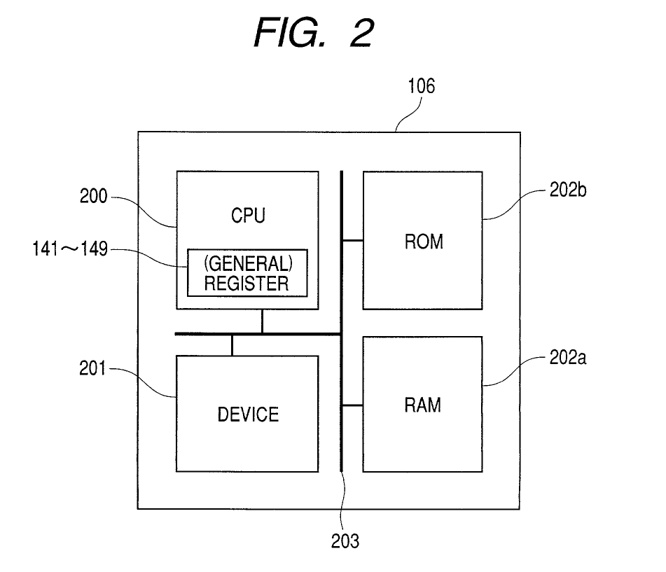

The description begins with an explanation of a method for allocating registers for various execution environments in accordance with the present invention and hardware for operating under the execution environments with reference to FIGS. 1 and 2. It should be noted that, in this embodiment, a source program is written in the C language, for example.

FIG. 1 is an explanatory diagram describing a processing flow in each execution environment of a method for allocating registers in accordance with the present invention.

FIG. 2 is diagram showing the configuration of hardware for executing a program under the various execution environments wherein registers are allocated in accordance with the present invention.

The present invention assumes that various execution environments 180 for generating an executable program are provided for the respective operating system 107.

The application body 100 describing an application program and the source code of the common function 102 has been entered into executable-program-generating tools in accordance with the ordinary procedure for creating an executable program. The tools include a preprocessor 181, a C compiler 182, an assembler 183, and a linker 184.

The preprocessor 181 is a tool for carrying out preprocessing prior to the C compiler 182. The preprocessing is conducted based on conditions includes data creation, skipping of inputs, inclusion of other programs and macro definitions. The C compiler 182 is a tool for analyzing syntax and contexts of the text code to generate proper assembler code. The assembler 183 is a tool for transforming the assembler code into machine language code which can be executed by a CPU 200. The linker 184 is a tool for selecting various program files from a library 190 and linking the various program files selected from the library 190 with the machine language code to generate a final executable program to be executed in the hardware 106. The library 190 includes executable environment programs dependent on any actual environment. Some executable environment programs required by functions of the application program are selected properly by the linker 184 so as to be linked with the machine language code.

An OS configurator 191 is also a software development tool for generating program code of an OS 107 customized according to desired functions of the OS 107.

The hardware 106 comprises the CPU 200, a device 201 and a working memory 202.

Eventually, the executable program under the OS 107 to be executed by the CPU 200 are loaded into the working memory 202.

The OS-specific execution environments 180 supported by the present invention can be implemented by a general-purpose computer such as a mainframe, a personal computer, or a workstation.

The following description explains a procedure for creating the hardware 106 for executing the execution program 110.

An OS-specific execution environment 180 is selected corresponding to the target OS 107 that has been defined on the general-purpose computer. Then by using the OS configurator 191 associated with the selected OS-specific execution environment 180, the program code of the customized target OS 107 is generated.

The linked program code is obtained as a result of linking the program code of the OS 107. The execution program 110 and the program 111 for unifying various execution environments are then loaded into the working memory 202. Alternatively, the program code of the OS 107 can also be loaded first into the working memory 202 and, then, linked program code is obtained as a result of linking the execution program 110 and the program 111 for unifying various execution environments which have been loaded into the working memory 202.

The hardware 106 shall include a mechanism capable of executing the execution program 110. It is assumed, however, that this embodiment employs a system LSI including the working memory 202 mainly for storing programs.

A typical configuration the hardware 106 is explained in detail by referring to FIG. 2 as follows.

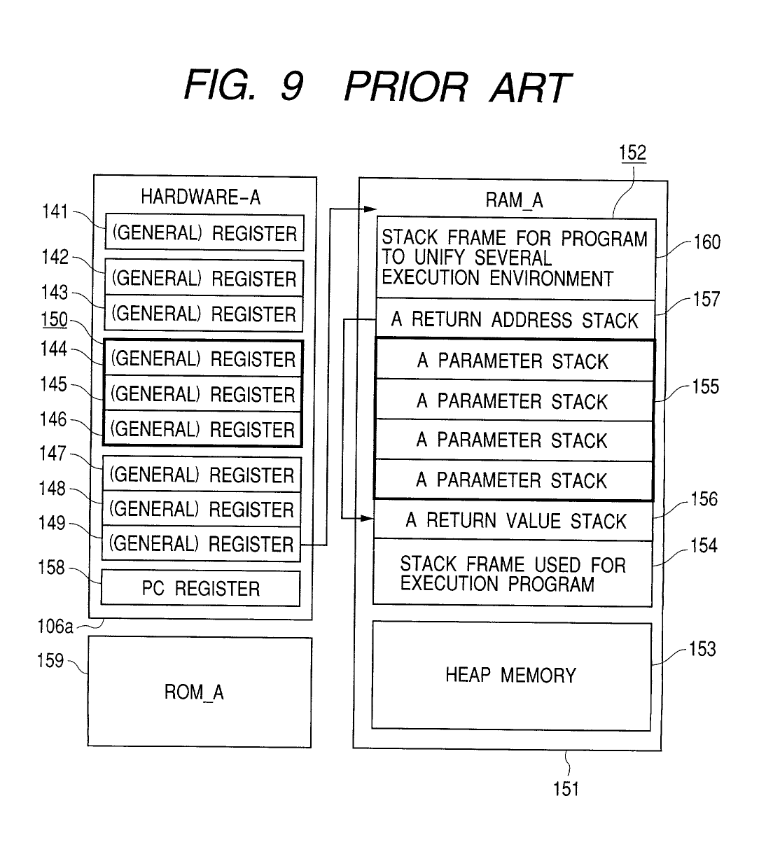

The CPU 200 for computing thereby executing instructions, is a main component of the hardware 106. The CPU 200 has general-purpose registers 141 to 149 as those explained earlier by referring to FIG. 9.

A RAM 202a is a memory area into which data can be written at any time. On the other hand, a ROM 202b is a read-only memory area into which data normally cannot be written. Usually, information is written into the ROM 202b during the process of fabricating the LSI. During normal operations, it is only possible to read out information from the ROM 202b but not to write in information into the ROM 202b. The execution program 110 and the OS 107 are stored in the RAM 202a or the ROM 202b to be read out and executed by the CPU 200.

The device 201 is a component of the hardware 106 and provided various functions. It the hardware 106 implements a system LSI, the device 201 is a processing circuit provided in the LSI for implementing special functions. For example, the processing circuit can be an I/O (input/output) unit, an ASIC (Application Specific Integrated Circuit), an FPGA (Field Programmable Gate Arrays), a DSP (Digital Signal Processor), or the like.

The I/O unit may include an A/D converter, a D/A converter, an RS232-C processing circuit, and an SCSI processing circuit. The ASIC is a dedicated processing circuit, such as an MPEG Video encoder or an MP3 decoder. An FPGA is an IC having an alterable hardware configuration. The DSP is an IC for processing a digital signal.

The CPU 200, the device 201, and the working memory 202 are connected to each other by a bus 203 that serves as a common signal path. The CPU 200, the device 201, and the working memory 202 exchange signals with each other through the bus 203.

[Method of Allocating General-Purpose Registers]

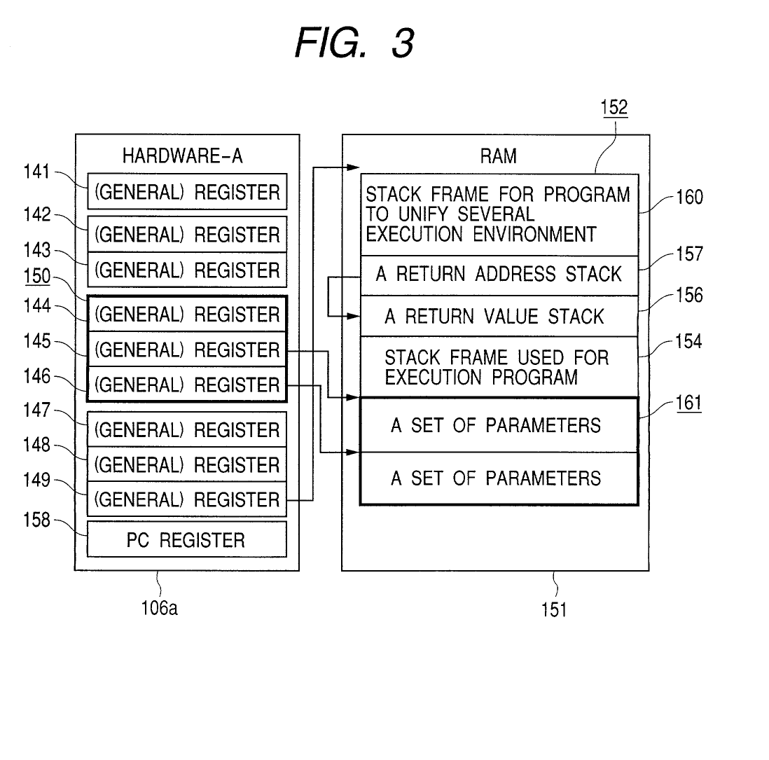

The following description explains a method for allocating general-purpose registers in accordance with the present invention by referring to FIG. 3, given understanding of the prior art described above.

FIG. 3 is a diagram showing how general-purpose registers are allocated in accordance with the present invention when the A program 111a for unifying various execution environments is called.

In the description of the prior art, it has been pointed out that, if the number of arguments to be passed, during transferring the control, to the program 111 for unifying various execution environments is greater than the number of registers in the parameter-storing register set 150 (i.e., the number of arguments of the common function interface 101 is greater than the number of registers in the parameter-storing register set 150), the excess arguments must be stored in the parameter stack 155 of the stack memory 152 as shown in FIG. 9, which causes a problem.

In order to solve the problem, when the control is transferred to the A program 111a for unifying various execution environments in the embodiment of the invention, an argument information set part 161 is created in the RAM 151 and a general-purpose register 145 is set with a value pointing to the argument information set part 161 as shown in FIG. 3 so as to prevent the parameter stack 155 from being filled up with data. By doing so, excess argument values are set in the argument information set part 161 at the time the A program 111a for unifying various execution environments is called. Thus, it is no longer necessary for the A execution program 110a to store arguments in the parameter stack 155 of the stack memory 152 or to locate the parameter stack 155. As such, the amount of workload incurred during the execution time is reduced. In addition, since the interface adopts an indirect approach for pointing to data stored in a contiguous area, i.e., the argument information set part 161, the utilization efficiency of the RAM is increased.

[Typical Coding Adopting the Method of Allocating General-Purpose Registers]

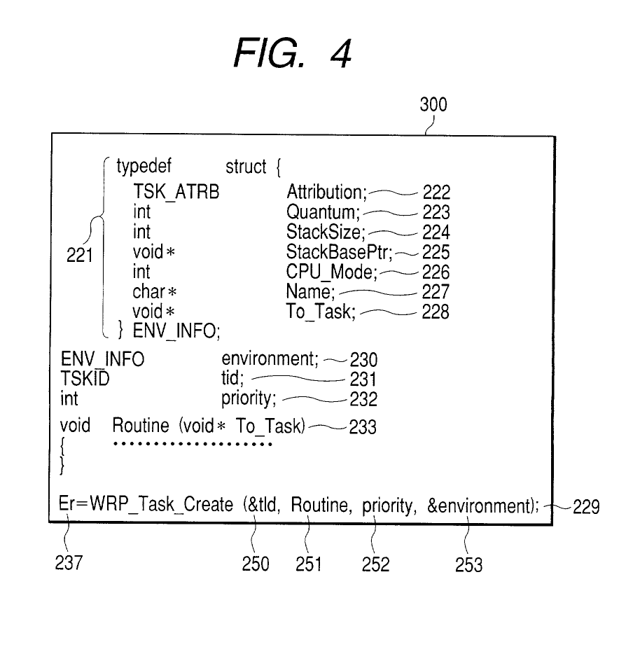

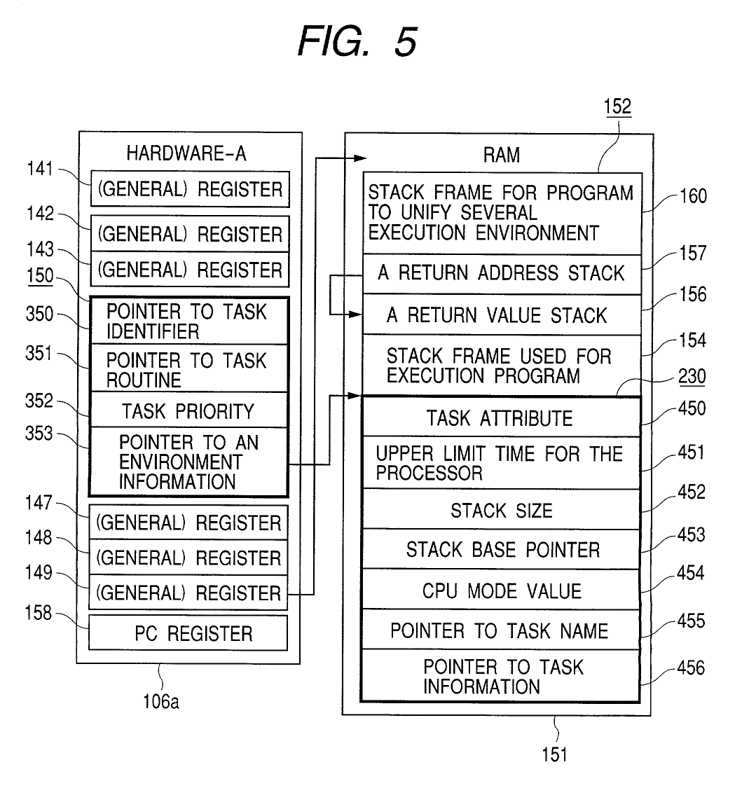

The following description uses a C-language coding example to explain the method of allocating general-purpose registers in detail by referring to FIGS. 4 and 5.

FIG. 4 is a diagram showing C-language typical coding which adapts the method of allocating general-purpose registers in accordance with the present invention.

FIG. 5 is a diagram showing how registers are allocated when the A program 111a for unifying various execution environments is called in the case of the coding shown in FIG. 4.

In this embodiment, the common function 102 called is written in the C language as WRP_Task_Create229 shown in FIG. 4. This function is a function of creating a task by calling a task routine function named Routine 223 which includes a description of task processing.

The number of arguments of the common function 102 named WRP_Task_Create229 is four. A return value is stored in a variable named Er237 in the RAM 151.

A variable “tid” denoted by reference numeral 231 is declared as a variable of a TSKID type. The first passed argument denoted by reference numeral 250 is the address of tid 231, i.e., a pointer pointing to the identifier of the task. A task identifier is the identifier of a task created by the OS 107. The tid 231 is a task identifier generated for identifying a task created by the OS 107.

The second passed argument 251 is the address of a task routine named Routine 233 that is declared as a function of a void type. The address of a task routine is a pointer pointing to the task routine. It should be noted that, in accordance with specifications of the C language, a routine name specified on a list of arguments is the address of a function prescribed by a routine identified by the routine name.

The third passed argument 252 is a variable named Priority 232 of an “int” type. The variable named Priority 232 is the priority level of the task to be created.

The fourth passed argument 253 is the address of data named environment 230 of an ENV_INFO type, i.e., a pointer pointing to environment information passed to the common function 102.

The information on an environment is explained in detail as follows.

In the C coding 300 shown in FIG. 4, a “typedef” statement defines a new structure type named ENV_INFO. Members of the newly defined structure type are described as follows.

Attribution 222 of a TSK_ATRB type is the value of an attribute of a task. The value of an attribute of a task indicates, among others, whether the application body 100 is written in the C language or the assembler language, and whether a floating-point processor or a digital signal processor will be used.

Quantum 223 of the “int” type is the task's upper-limit time value for occupying the processor. The task's upper-limit time value for occupying the processor is a maximum time for the task to occupy the CPU 200.

StackSize 224 of the “int” type is the size of a stack. StackSize 224 specifies a minimum size of a memory stack 152 required by the task at the run time.

StackBasePtr 225 of a “void*” type is the pointer which points to the base of the stack when the task is initialized.

CPU_Mode 226 of an “int” type is a value representing the mode of the CPU 200. The mode of the CPU 200 indicates whether or not the CPU 200 uses a multimedia instruction in executing the generated task.

Name 227 of a “char*” type is the address of an area for storing a string of characters representing the name of the generated task.

To_Task 228 of the “void*” type is the address of task information to be passed to the task routine named Routine 223 when the OS 107 creates the task.

In the C coding 300 shown in FIG. 4, a variable named environment 230 of the newly defined ENV_INFO type is declared. This variable facilitates porting of the application body 100 from an OS 107 to another OS 107. That is, when the application body 100 is used in new hardware 106, the execution program 110 and a new OS 107 for the new hardware 106 need to be generated by using another OS-specific execution environment 180 for the new OS 107 and the new hardware 106. In this case, the information defined by the structure 221 of the ENV_INFO type needs to be modified. In this way, the execution program 110 and the new OS 107 can be ported into the new hardware 106 with ease.

As described above, To_Task 228 of the “void*” type is the address of task information to be passed to the task routine named Routine 233 when the OS 107 creates the task.

When an execution program 110 obtained by compiling the source program 300 is executed under the OS 107 suitable for the program, the four arguments described in the common function 239 are passed to the program 111 for unifying various execution environments. As described earlier, the four arguments are a pointer pointing to the identifier of a task, a pointer pointing to the routine of the task, the priority of the task, and a pointer to the information on an environment.

In the A program 111a for unifying various execution environments, a function of the A hardware 106a is used by initiating a system call of the A OS 107a. As shown in the example of FIG. 4, the system call 229 generates a task by passing a pointer pointing to a routine representing the task.

The following description explains a state, in which an executable program occupies hardware resources after the common function 102 is called, by referring to FIG. 5.

The number of general-purpose registers in the parameter-storing register set 150 of the CPU 200 is set as four.

In this case, the arguments of the common function 102 named WRP_Task_Create 229 are stored in the registers 350 to 353 respectively. Specifically, a pointer 250 pointing to the identifier of a task, a pointer 251 pointing to the routine of the task, the priority level 252 of the task, and a pointer 253 pointing to information on an environment listed from the left to the right at the bottom of FIG. 4 are stored in the registers 350 to 353 as a task identifier pointer 350, a task routine pointer 351, a task pointer 352 and an environment information pointer 353, respectively, in FIG. 5.

The environment information pointer 353 is a pointer pointing to a RAM area for storing information of an environment. Pieces of information defined from the top to the bottom in the structure of the ENV_INFO type in FIG. 4 are stored at locations 450 to 456 in the RAM as a task attribute value 450 in FIG. 5, including a processor upper-limit time value 451, a stack size 452, a stack base pointer 453, a CPU mode value 454, a task-name storage area pointer 455 and a task-information storage area pointer 456.

This area corresponds to the argument information set part 161 explained earlier by referring to FIG. 3.

As described above, by creating the argument information set part 161, arguments from the parameter-storing register set 150 are collected in the argument information set part 161, which makes the parameter stack 155 dispensable.

In accordance with the present invention, it is possible to provide a method for allocating registers for various execution environments, a method of generating executable programs to be executed in the various execution environments, and an LSI including an embedded program created by the method of allocating registers for the various execution environments and the method of generating executable programs to be executed in the various execution environments. Considering how general-purpose registers are allocated when a program for unifying various execution environments is called during the generation of an executable program to be executed in the various execution environments, the memory utilization efficiency is thus improved while the program execution speed is at least maintained the same.

The foregoing invention has been described in terms of preferred embodiments. However, those skilled in the art will recognize that many variations of such embodiments exist. Such variations are intended to be within the scope of the present invention and the appended claims.

What is claimed is:

1. A method for allocating data to a plurality of general purpose registers in a CPU for a plurality of execution environments, whereby programs executed under said execution environments includes a first program for implementing a user-specific function and a second program for unifying said plurality of execution environments, comprising:
allocating a data area in RAM for storing environmental information of said second program;
assigning one of said plurality of general purpose registers for storing a pointer of the environmental information in the RAM; and
compiling the first program for at least one of said plurality of execution environments.

2. The method for allocating data to a plurality of general purpose registers in a CPU for a plurality of execution environments according to claim 1, whereby the number of parameters defining the environmental information is equal to or bigger than the number of general purpose registers.

3. The method for allocating data to a plurality of general purpose registers in a CPU for a plurality of execution environments according to claim 1, whereby the number of reserved general purpose registers is equal to or bigger than the number of actually used general purpose registers.

4. The method for allocating data to a plurality of general purpose registers in a CPU for a plurality of execution environments according to claim 3, further comprising a step of defining arguments for passing information on at least one task for implementing the first program, said arguments comprise:
an address of a memory location for storing an identifier for controlling and managing said task;
a start address of an execution routine for implementing said task;
a priority level assigned to said task to occupy the RAM; and
a start address of a memory area for storing a said parameters.

5. The method for allocating data to a plurality of general purpose registers in a CPU for a plurality of execution environments according to claim 3, whereby said parameters include at least one of:
a task attribute of at least one task for implementing the first program;
an upper-limit time for said task to be executed;
a size of a stack required by said task;
a stack base pointer which points to a location in said stack when said task is activated;
a CPU mode value indicating whether or not said task requires the CPU employed the RAM to execute a multimedia instruction;
an address of a memory area for storing a name of said task; and
a start address of a memory area for storing task information to be passed to the CPU at activation of said task.

6. A method for allocating data to a plurality of general purpose registers in a CPU for a plurality of execution environments according to claim 1, whereby the first program is compiled simultaneously for at least two of said plurality of execution environments.

7. A method for allocating data to a plurality of general purpose registers in a CPU for a plurality of execution environments according to claim 1, whereby the method is implemented by a computer.

8. A computer program product for allocating data to a plurality of general purpose registers in a CPU for a plurality of execution environments, wherein programs executed under said operation systems includes a first program for implementing a user-specific function and a second program for unifying said plurality of execution environments, comprising:
a module for allocating a data area in RAM for storing environmental information of said second program;
a module for assigning one of said plurality of general purpose registers for storing a pointer of the environmental information in the RAM; and
a module for compiling the first program for at least one of said plurality of execution environments.

9. An integrated circuit comprising:
a CPU having a plurality of general-purpose registers;
a memory; and
a device for allocating data to a plurality of general purpose registers in the CPU for a plurality of execution environments, wherein programs executed under said execution environments includes a first program for implementing a user-specific function and a second program for unifying said plurality of execution environments, comprising:
means for allocating a data area in RAM for storing environmental information of said second program;
means for assigning one of said plurality of general purpose registers for storing a pointer of the environmental information in the RAM; and
means for compiling the first program for at least one of said plurality of execution environments.

10. The integrated circuit according to claim 9, wherein the number of parameters defining the environmental information is bigger than the number of general purpose registers.
